(19) United States
(12) Patent Application Publication
(10) Pub. No.: US 2005/0241479 A1
(43) Pub. Date: Nov. 3, 2005

(54) Filter materials for absorbing hydrocarbons

(75) Inventors: Jeffrey I. Lebowitz, Drexel Hill, PA (US); Joseph W. Lovette, Newark, DE (US); Chiu Y. Chan, Wilmington, DE (US)

Correspondence Address: CONNOLLY BOVE LODGE & HUTZ, LLP, P O BOX 2207, WILMINGTON, DE, 19899, US

(73) Assignee: Foamex L.P., Linwood, PA (US)

(21) Appl. No.: 10/833,857

(22) Filed: Apr. 28, 2004

(51) Int. Cl. B01D 53/02

(52) U.S. Cl. 95/146; 96/134

(57) ABSTRACT

A porous filter medium forms a filter for extracting hydrocarbons from vapors emitted from a motorized vehicle, device or appliance fuel tank. The filter medium is a polymer network of a foam, nonwoven or collection of particles, and has a butane working capacity (W/W %) of 4.0 percent or higher.

### FIELD OF THE INVENTION

This invention relates to a filter material to capture hydrocarbon evaporative emissions, such as during refueling, to prevent or limit such hydrocarbons from being emitted into the atmosphere, and to an evaporative emission control system incorporating such filter material.

### BACKGROUND OF THE INVENTION

Environmental Protection Agency (“EPA”) regulations require gasoline and diesel powered passenger cars and light trucks to incorporate on board hydrocarbon refueling emissions controls. As fuel is introduced into a motor vehicle's tank, the displaced vapors from the tank are directed to the refueling emissions controls. The goal is for the on board system to capture about 95 percent of the refueling emissions to limit the amount of volatile organic compounds (“VOCs”) and toxins emitted into the atmosphere during refueling. The VOCs that evaporate from gasoline during vehicle refueling contribute to urban ozone or smog formation.

Currently, vehicles use activated carbon-filled canisters to capture evaporative emissions. Carbon is “activated” by treating with steam or chemicals to increase porosity and generate a high surface area so that the activated carbon more readily adsorbs various chemical species. The activated carbon in the canister either is in the form of loose powders, granules or pellets, or in the form of a honeycomb extrusion, or a combination of these. The gas tank and fill pipe are designed so that when refueling the vehicle, fuel vapors in the tank travel to the activated carbon-packed canister where the vapors are adsorbed. Each filled canister weighs up to about 10 pounds. The carbon granules or pellets settle after being subjected to vehicle movement, which can change the flow path and alter filter performance. Carbon powders, granules or pellets generate dust, and the honeycomb extrusions lack significant vibrational stability, leading to breakage and dust generation. Lower cost, lighter weight, more resilient and more reliable alternatives to the activated carbon-packed canisters are sought.

One activated carbon canister system is shown in U.S. Pat. No. 6,540,815 (Hiltzik). In this patent, an emissions control system canister has a vent side that incorporates multiple beds of adsorbent materials that may be spaced apart by inert fillers or voidages, or has an adsorbent-containing monolith, such as a honeycomb, that has a desired void volume. When used, the inert fillers can be porous mats of foam. Such vent side absorbents are stated to have butane adsorption of about 6 g/dL. The '815 patent mentions activated carbon formed from various raw materials, including porous polymers, as a hydrocarbon adsorbent. In the working examples, the '815 patent uses foams only as inert or nonadsorbing material in combination with adsorbing activated carbon pellets. Such foams are not identified as hydrocarbon vapor adsorbents.

U.S. Pat. No. 6,464,761 (Bugli) discusses an air induction filter assembly that includes a reticulated multi-layer foam with carbon impregnation to remove residual hydrocarbon vapors diffusing through the inlet manifold of an engine after the engine is shut off. The '761 patent states that the carbon impregnated foam layer is optional in non-automotive applications where hydrocarbon adsorption is not required.

Foams have been used as fluid filtering media for different applications. SIF® foams from Foamex International Inc. of Linwood, Pa. are reticulated flexible polyester or polyether urethane foams with pore sizes from 10 to 110 pores per linear inch that may be used, for example, as gasoline fuel filters in chainsaws and other small engines. These foams filter particulates from liquids. PROTECTAIR® II foams, also from Foamex International, are reticulated polyether foams with pore sizes from 20 to 35 pores per linear inch that may be used, for example, in air filters to filter particulates from an air stream. Heretofore, such foams have not been used to absorb hydrocarbons entrained in a gas stream.

In the 1980's, Scottfoam Corporation, a predecessor to Foamex International, offered an activated charcoal impregnated SIF® foam for use as a shoe sole insert under the trademark SORBACELL™. The Technical Data Sheet for this foam indicates that the foam was impregnated with high loadings (2 oz./square yard) of finely divided activated carbon particles, which allowed the coated foam to remove particulate material and adsorb some gaseous contaminants from an air stream.

Thus, the background art considered it necessary to treat or coat urethane or polymer filter material, such as foam, with activated carbon or other hydrocarbon adsorbent material in order to have a satisfactory butane working capacity and satisfactory hydrocarbon adsorption. Coated foams, however, can have higher weight, can be less resilient and can be more apt to generate particle contamination from flaking. Thus, it would be desirable to have a lower weight and more resilient filter material with satisfactory butane working capacity for use in evaporative hydrocarbon emissions systems.

### SUMMARY OF THE INVENTION

A first aspect of the invention is a method for removing or extracting hydrocarbons from a gaseous stream emitted from a fuel tank during refueling a motor vehicle, device or appliance with a hydrocarbon-based fuel consuming engine. According to the method, a filter is installed in a flow path established between the fuel tank and an exhaust from the fuel tank. The filter comprises a polymer network and has a butane working capacity on a weight percent basis (W/W %) of at least 4.0 percent, more preferably at least 8.0 percent.

The polymer network may comprise a foam, such as a polyether or polyester polyurethane foam, with a pore size between about 3 and 300 ppi, preferably between about 20 and about 90 ppi. The foam may be thermally or chemically reticulated. Alternate polymer materials to form the polymer network include urethanes, melamine, acrylics, polyethylenes, polyimides, polyvinyl acetate, polyvinyl alcohol, ethylene vinyl acetate and combinations of polymers.

The polymer network alternatively may comprise a nonwoven polymer, a collection of polymer particles, a collection of shredded particles of foam, a monolith of foam, multiple layers of foam, a coiled sheet of foam, or any combination thereof, that can be loaded into an inner chamber of a housing or container so as to have a sufficient air permeability.

Whether a foam, nonwoven or other polymer network is used, preferably, the polymer network has an air permeability of 0.1 to 20 inches water pressure drop, most preferably 0.1 to 5 inches water pressure drop.

A coating optionally may be applied to a portion of the polymer network to adjust efficacy of the filter. The coating optionally may include activated carbons, silicas, silicates, aluminosilicates, filter agents, molecular sieves, flame retardants, electrically conductive materials, antimicrobial additives, germicides, pigments and colorants.

In a second aspect, the invention comprises a system for extracting evaporative hydrocarbon emissions from a motorized vehicle, device or appliance. In this system, a filter canister or other container has a housing defining an inner chamber, an inlet through which a gas stream containing a hydrocarbon enters the inner chamber, and an outlet from which a gas stream exits the inner chamber. A filter, such as described above, comprising a polymer network and having a butane working capacity on a weight percent basis (W/W %) of at least 4.0 percent, preferably at least 8.0 percent, is inserted into the housing.

The filter may be formed as a single unit or as a combination of two or more filter units inserted into the housing. For example, the housing inner chamber may be generally cylindrical and the filter may be formed as one or more circular disks stacked one atop the other and inserted into said inner chamber.

### BRIEF DESCRIPTION OF THE DRAWINGS

The present invention will be described in the following detailed description with reference to the following drawings:

FIG. 1 is a schematic diagram of a fuel system with enhanced evaporative emissions control for capturing hydrocarbon vapors emitted during refueling which includes a filter canister containing a filter material according to the invention;

FIG. 2 is a front elevational view in partial cross section of a first embodiment of a filter canister containing a stack of filter material disks according to the invention;

FIG. 3 is a cross-sectional view taken along line 3-3 in FIG. 2;

FIG. 4 is a front elevational view of a second embodiment of a filter canister containing a filter material according to the invention;

FIG. 5 is a cross-sectional view taken along line 5-5 in FIG. 4;

FIG. 6 is a schematic diagram of a dip and nip coating apparatus;

FIG. 7 is a graph of Butane Working Capacity (“BWC”) versus Time in seconds comparing the butane absorption of urethane foam and urethane foam coated with an activated carbon coating;

FIG. 8 is a graph of BWC in percent versus foam pore size in pores per inch for coated and uncoated foams of varying pore size;

FIG. 9 is a graph of maximum butane absorbed versus foam pore size for coated and uncoated foams of varying pore size; and

FIG. 10 is a graph of force versus strain showing hysteresis curves for a polyurethane foam filter media as compared to a conventional honeycomb carbon extrusion.

### DETAILED DESCRIPTION OF THE PREFERRED EMBODIMENTS

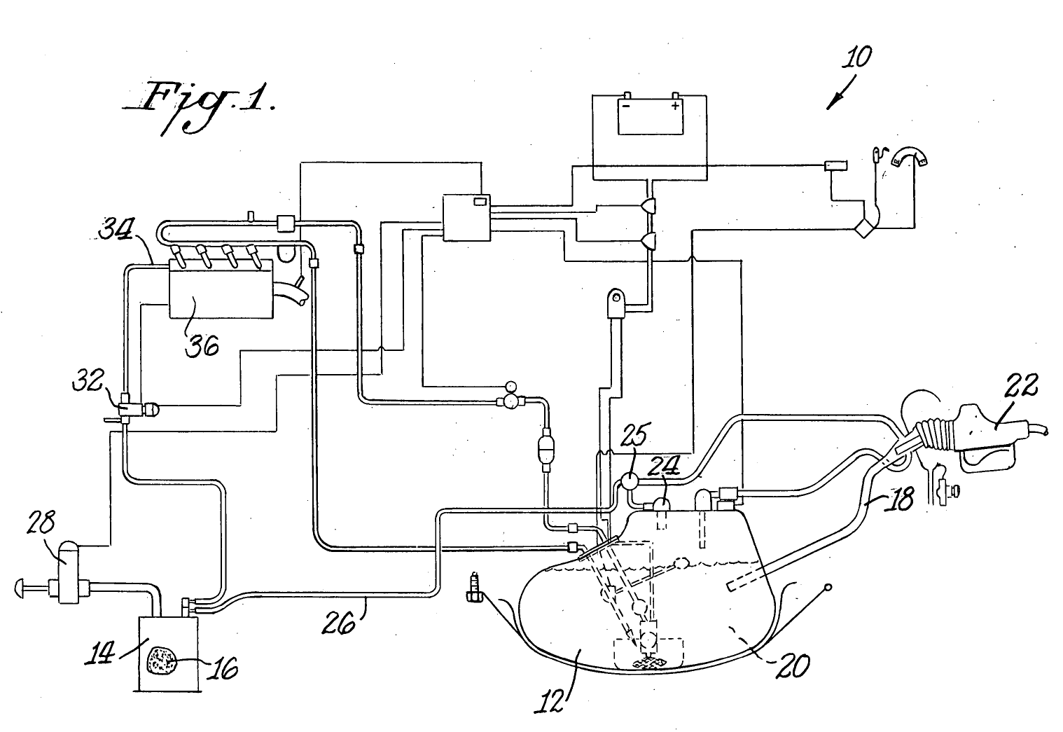

Referring first to FIG. 1, a fuel system 10 with enhanced evaporative emissions controls has a fuel tank 12 into which fuel 20 may be poured from pump nozzle 22 via fuel inlet 18. The tank is provided with a fuel tank vent valve 24 in fluid communication with a control valve 25 that in turn is in fluid communication with a fuel tank vent tube and fittings 26 leading to the canister 14 that is filled with an a filter 16. A canister vent valve 28 and purge line 30 are provided as outlets from the canister 14. The canister purge line 30 leads to a purge vapor management valve 32 in fluid communication with a purge port 34 to the fuel injectors of the engine 36 and the exhaust therefrom.

As liquid hydrocarbon fuel, such as gasoline, is pumped via nozzle 22 into the fuel tank 12, the gas vapors in the vapor space above the fuel in the tank are displaced by the liquid fuel 20. Such displaced gas vapors are not permitted to escape from the fuel tank to the atmosphere. Rather, such gas vapors flow from the tank through the fuel tank vent valve 24 and control valve 25 into the fuel tank vent tube and fittings 26 leading to the canister inlet. The gas vapors pass through the filter 16 within the canister 14 wherein a substantial portion of the hydrocarbon species in the gas vapors are drawn out of the vapor and attach to the filter 16. The gaseous fluid emitted from the filter 16 then flows through the purge line 30 and through the purge vapor management valve 32 to the purge port 34 into the fuel injector manifold in the engine 36.

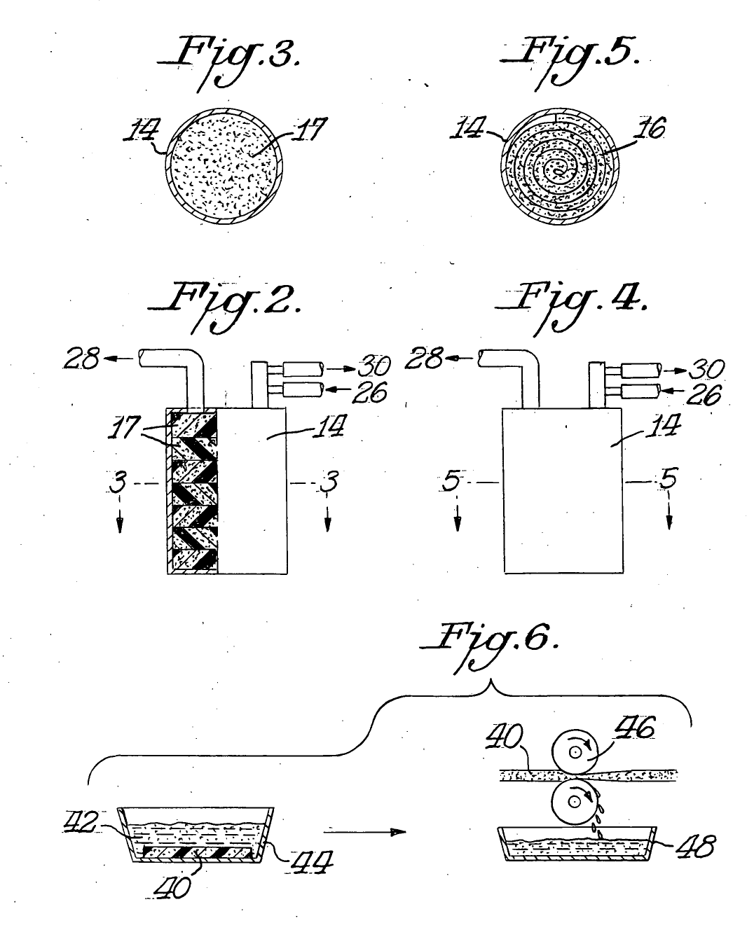

Referring next to FIGS. 2 and 3, a system for evaporative hydrocarbon emissions control has a canister 14 that is formed as a generally cylindrical housing from materials resistant to corrosion, including aluminum, stainless steel, plastics and composite materials. The housing defines a cylindrical chamber for holding a filter medium. While the canister 14 is illustrated as having a generally cylindrical shape, other cross-sectional shapes are possible. The canister dimensions are selected so that the canister will fit within space within the exhaust system and so that the sufficient vapor flow rates through the canister may be maintained.

The filter medium shown in FIG. 2 comprises multiple cylindrical blocks 17 of urethane foam inserted inside the chamber. The cylindrical blocks 17 are stacked one atop the other to fill the chamber. For example, each cylindrical block may have a diameter of about three inches and a thickness of about one inch. The blocks may be of the same or different urethane foam or other hydrocarbon absorbing material. The blocks may be of different shape besides cylindrical to fit within chambers having different inner housing configurations. Alternatively, the filter medium may be formed as a one-piece block or monolith of foam that fills the chamber.

Referring next to FIGS. 4 and 5, in an alternate hydrocarbon evaporative emissions control system, the filter medium comprises a sheet 16 of urethane foam that has been coiled or rolled like a jelly roll to form a cylinder that fits within the cylindrical chamber of the canister 14. For example, the sheet has a length of 8 to 16 inches, a width of 5 to 10 inches and a thickness of 0.25 to 1 inches, most preferably a length of 12 inches, a width of 6 to 7 inches and a thickness of 0.5 inches.

The filter medium may be formed of a urethane foam, wherein “urethane” means generally the reaction product of an isocyanate and a polyol that contains one or more hydroxyl groups. A preferred urethane foam is a polyether polyurethane foam with a pore size in the range of 3 to 200 pores per linear inch, more preferably from 20 to 90 pores per linear inch, and most preferably from 30 to 80 pores per linear inch. The preferred polyurethane foam has a density in the range of 0.6 to 20 pounds per cubic foot, preferably about 1.3 to 4 pounds per cubic foot.

An alternate urethane foam is a polyester polyurethane foam with a pore size in the range of 3 to 200 pores per linear inch, more preferably from 20 to 90 pores per linear inch, and with a density in the range of 0.6 to 20 pounds per cubic foot, preferably, 1.3 to 4 pounds per cubic foot.

The urethane foam optionally may be thermally or chemically reticulated or networked to remove the cell windows, leaving a network of strands or struts. Reticulation increases void volume and air permeability. A thermal reticulation process is described, for example, in U.S. Pat. No. 3,175,025 to Green, et al. and U.S. Pat. No. 3,171,820 to Volz, et al. A chemical reticulation process is described, for example, in GB 858,127 to Scott Paper Company. Where an ester polyurethane foam is selected for the filter medium, we have found that hydrocarbon absorption is enhanced when such foam has been chemically reticulated.

The filter medium also may be formed from other polymers, such as other urethanes, polyethylenes, polyimides, melamines and acrylics, polyvinyl acetates, polyvinyl alcohols, ethylene vinyl acetates or combinations. The polymers may be foamed, or may be formed into a nonwoven having sufficient fluid/air permeability to serve as a filter. Needled or bonded nonwoven structures formed from fibers or strands of the polymers may be used. U.S. Pat. Nos. 2,958,593, 3,324,609 and 4,490,425 describe various methods of forming nonwoven fiber structures and fabrics.

In addition to a sheet of polyurethane foam or a polymeric nonwoven, the polymer network forming the filter medium alternatively may comprise a collection of polymer particles, a collection of shredded particles of foam, a monolith of foam, multiple layers of foam, a coiled sheet of foam, or any combination thereof

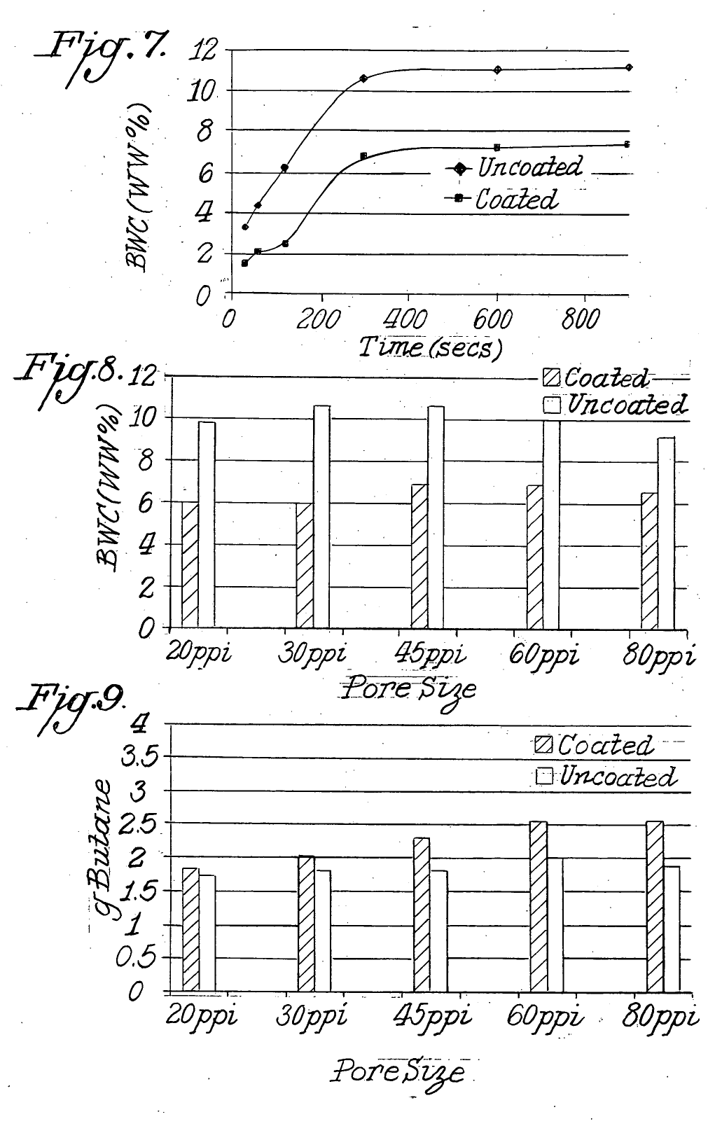

While we have found that a urethane foam without any coating achieves a desired hydrocarbon absorption and an effective butane working capacity for use as a filter medium in an evaporative hydrocarbon emissions system, it may be desirable to coat the foam before use to vary its performance. If the foam is to be coated or impregnated, one known method is a dip and nip method such as shown in FIG. 6. In the dip and nip method, the foam sheet 40 is immersed in a liquid mixture or slurry 42 of binder and optionally an adsorbent, such as activated carbon, that is held in a tray 44. The wetted foam sheet 40 is then compressed in the nip between a pair of compression rollers 46. Excess slurry is squeezed out of the wetted foam sheet and falls into a recycling tray 48. The dip and nip may be repeated for multiple cycles to achieve a desired coating loading. The impregnated foam is dried before it is inserted into the filter canister chamber.

Representative coating binders include: acrylic binders, acrylonitrile binders, epoxy binders, urethane binders, natural or synthetic rubbers, PVC emulsion binders, and/or a blend of various binders. Preferably the binders are water based emulsions. The binders with or without added adsorbents may be applied to the foam structure to adjust the hydrocarbon adsorption/absorption efficacy.

Representative activated charcoals include: plant, wood and/or other renewable material-sourced charcoals, and coal. These activated carbon powders preferably have particle sizes in the range of 100 to 400 mesh (4 to 150 micron), most preferably 325 mesh (45 micron or less). Automotive emission control grade activated carbons are available from various supplies, including MeadWestvaco, Norit, Calgon, Carbochem and Jacobi. One preferred activated carbon available from MeadWestvaco (Covington, Va.) is NUCHAR® SA, which has a minimum Iodine number of 900, an apparent density of 21 to 23 lbs/ft³ (337-369 kg/m³), a surface area of 1400 to 1800 m²/g and a pore volume to 1000 Å of 1.1 to 1.3 (cc/g).

In addition to activated carbons or charcoals, other possible adsorbents include silicas, silicates, such as diatomaceous earth metals, filter agents, such as Celatom FW80 (CAS# 68855-54-9), and aluminosilicates, such as Fuller's Earth (CAS# 8031-18-3) or Montmorillonite KSF (CAS#1318-93-0).

If a coating is applied to a foam, preferably, one or more binders and one or more activated carbon powders or other adsorbents are combined together with water to form a coating mixture that may be impregnated into or coated onto the foam. In a particularly preferred embodiment a rheology modifier or thickening agent is incorporated into the coating mixture. Other additives may be incorporated into the coating mixture, such as defoamers, surfactants, wetting agents and dispersants.

The filter medium preferably has an air permeability from 0.1 to 20 inches water pressure drop, more preferably from 0.1 to 5 inches water pressure drop, most preferably up to 2 inches water pressure drop. Typically, when a motor vehicle fuel tank is refilled, the displaced vapors from the tank enter the filter at a flow rate of about 200 cc/min. The hydrocarbon molecules in the vapors attach to the foam filter. Thereafter, when the motor vehicle engine is on, the engine pulls a vacuum and draws air at 20,000 cc/min through the filter. This larger flow rate pulls the hydrocarbon vapor out of the filter and the hydrocarbon molecules away from the filter medium (and the activated carbon if the filter medium is coated), sending them to the engine for combustion. The hydrocarbon absorbing sites are then available to absorb and/or adsorb hydrocarbon molecules during the next re-fueling.

The filter medium has utility within evaporative hydrocarbon emissions control systems used in various motorized vehicles, devices and appliances, such as automobiles, sport utility vehicles, boats, motor cycles, motor scooters, snow mobiles, snow blowers, pick up trucks, all terrain vehicles, lawn mowers, chain saws, power washers, and air blowers. The filter medium may be installed within a canister or housing through which an air or gas stream with entrained hydrocarbons may be passed to form a hydrocarbon emissions control system.

The following examples further illustrate the present invention. All parts and percentages are expressed by weight unless otherwise specified.

### EXAMPLES

Polyurethane Foam Compositions

Polyether polyurethane foam samples were prepared from the following ingredients:

| | Parts per hundred | Parts per hundred |
|---|---|---|
| Component | Ether Foam | Graft Ether Foam |
| VORANOL 3010 polyol | 100.0 | 85.0 |
| HS-100 | 0.0 | 15.0 |
| TDI | 63.8 | 56.8 |
| KOSMOS 5-N | 0.31 | 0.31 |
| THANCAT NEM | 1.26 | 1.26 |
| K-29 | 0.08 | 0.08 |
| BLACK PIGMENT | 4.88 | 4.88 |
| L-620 | 0.94 | 0.94 |
| C-124 | 0.79 | 0.79 |
| Deionized water | 4.72 | 4.3 |

“Parts per hundred” denotes parts by weight per hundred parts polyol. VORANOL 3010 is a polyether polyol from Dow Chemical Company. HS-100 is a graft polyol from Bayer. Generally, a graft polyol such as HS-100 increases the stiffness of the resulting foam. TD80 is toluene diisocyanate also from Dow. KOSMOS 5-N and K-29 are tin catalysts from Degussa. THANCAT NEM is an amine catalyst from Air Products and Chemicals of Allentown, Pa. C-124 is an amine catalyst from Crompton. L-620 is a surfactant from GE Silicones (formerly Osi Specialties).

Polyester polyurethane foam samples were prepared from the following ingredients:

| | Parts per hundred |
|---|---|
| Component | Ester Foam |
| 1102-50A polyol | 100.0 |
| TD80 | 46.5 |
| SE-232 | 1.0 |
| 33LV | 0.3 |
| THANCAT NEM | 1.2 |
| Deionized water | 3.6 |

1102-50A is a polyester polyol from inolex. SE-232 is a surfactant from GE Silicones. 33LV is a catalyst and THANCAT NEM is an amine catalyst both from Air Products and Chemicals of Allentown, Pa.

In the examples, the polyol(s), water, surfactants, catalysts and pigments were mixed together in a first process stream and combined with the isocyanate at the mixing head of a conventional foam mixer. In some cases, foam densities were adjusted by adjusting water level. The foaming mixture was deposited from the mixer onto a moving conveyer and allowed to rise at room temperature and pressure as it was conveyed away from the mixer. The foam then was allowed to cure for 24 hours before further processing.

To increase air permeability, some of the foam samples were reticulated (either thermally or chemically as indicated below) to remove cell windows from the foam structure to leave a network of interconnected strands with voids therebetween. The voids create fluid flow paths through the reticulated foam structure.

The Butane Working Capacity (BWC) on a weight percent basis (W/W %) and butane absorption was evaluated for polyurethane foams of varying pore size without any adsorbent coatings as reported in Table 1 below.

A portion of the foam samples were also coated with an activated carbon coating formulation as set out below.

Activated Carbon Coating Formulation

| Component | Weight Percent |
|---|---|
| NUCHAR ® SA carbon | 8.5 |
| BYK-020 | 0.7 |
| RHOPLEX E-358 | 16.0 |
| RHOPLEX HA-12 | 9.0 |
| ACRYSOL RM-825 Premix | 30.5 |
| Deionized water | 35.3 |

The ACRYSOL™ RM-825 Premix consisted of 50% by weight RM-825 with the balance (50% by weight) deionized water. ACRYSOL™ RM-825 is a rheology modifier and thickening agent available from Rohm and Haas Company of Philadelphia, Pa. RHOPLEX™ E-358 and RHOPLEX™ HA-12 are acrylic binders also available from Rohm and Haas Company.

NUCHAR® SA is an activated carbon available from MeadWestvaco (Covington, Va.). Activated carbon powders are also available from Carbochem (Ardmore, Pa.), and Norit (Atlanta, Ga.). The NUCHAR® SA activated carbon powder had a Butane Activity of 61.3%, a surface area of 1926 m²/g, an Iodine number of 1213, and a particle size such that 90% of all particles had diameters of less than 50 microns.

BYK-020 is a defoamer available from BYK-Chemie (Wallingford, Conn.).

The activated carbon, BYK-020, E-358 and HA-12 were mixed with approximately one half of the water under ambient temperature and pressure to form a slurry. The RM-825 Premix and remaining water were then added to the slurry and the mixture was mixed with a blender for approximately five to ten minutes to form the activated carbon coating formulation.

The coating formulation was then poured into a holding container or tray. Each sheet of reticulated polyether polyurethane foam having dimensions of 12×18×0.5 inch was immersed into the coating formulation and removed from the coating formulation and passed through the nip between two compression rollers to force the coating formulation through the thickness of the foam sheet thereby coating the foam strands. For the examples, a single impregnating step was used. Each coated foam sheet was then oven dried at 170° C. for twenty to thirty minutes.

Weight gain was calculated by weighing the foam sheet prior to coating and again after coating (weight gain=(coated weight−initial weight)/initial weight). The samples had coating loadings (weight gains) of from 95 to 105%.

“Flake off” is a subjective standard graded as severe, moderate, slight or none, and determined by collecting the particles that fell from the coated foam as the foam was rolled to form the cylinder shape. Coated foams that have excessive flake off could lead to processing difficulties, such as but not limited to, difficulty installing the coated filter into a canister. Severe flake off also may lead to other difficulties, such as but not limited to, reduced vibration stability, clogged vapor lines, and faulty activation of engine warning lights. The solid:binder ratio and/or percent pickup can be optimized to limit flake off.

Butane Working Capacity (BWC) on a weight percent basis (W/W %) was determined according to the following procedure. This procedure is a variant of ASTM D5228, which is the Standard Test Method for Determination of the Butane Working Capacity of Activated Carbon. Coated and uncoated foam samples were cut into disk shapes having a diameter of about 3 inches and a thickness of about 0.5 inch. The samples were dried in an oven at 120° C. for one hour, then cooled in a dessicator for 15 minutes. The tare weight (“B”) of an empty cylindrical canister (6 inches long with an inner diameter of 3 inches) was recorded. Thirteen foam disks were loaded into the canister one atop the other to fill the canister volume. The filled canister was then weighed. The “initial weight” (“C”) of the foam-filled canister was recorded.

The foam-filled canister was then attached to a butane source and purged with butane for 15 minutes. The setting on the rotameter was 144 for a flow rate of 250 ml/min. The canister then was closed with a stopper and removed from the butane source. The butane-purged canister was then weighed and the “butane saturated weight” (“D”) was recorded.

The butane-purged canister was then attached to a nitrogen gas source and purged with nitrogen for 30 minutes. The setting on the rotameter was 150 for a flow rate of 400 ml/min. After the nitrogen purge, the canister was closed with a stopper and removed from the nitrogen source. The final weight of the purged canister was recorded (“E”).

The weight (grams) of butane absorbed was calculated as “D”−“E”. The weight (grams) of the foam filter medium was calculated as “C”−“B”. BWC on a weight percent basis (W/W %) was calculated as grams butane divided by grams of foam filter medium, which is then multiplied by 100%.

Each foam grade and pore size, coated and uncoated, was tested using this procedure at least twice, and the average values were recorded.

The honeycomb extrusion activated carbon filter medium presently used in the automotive industry had a butane working capacity of 7.0 to 8.0%.

The BWC values for filters with either uncoated or coated foams according to the invention are set out in Tables 1 and 2 and illustrated in FIGS. 7, 8 and 9.

TABLE 1
Dynamic Butane Absorption

| Butane Dwell | Uncoated | BWC | Coated | BWC |
|---|---|---|---|---|
| Time (sec) | g Butane | (W/W %) | g Butane | (W/W %) |
| 30 | 0.56 | 3.3 | 0.50 | 1.5 |
| 60 | 0.74 | 4.4 | 0.67 | 2.1 |
| 120 | 1.05 | 6.1 | 0.80 | 2.4 |
| 300 | 1.75 | 10.6 | 2.19 | 6.7 |
| 600 | 1.77 | 11.0 | 2.33 | 7.1 |
| 900 | 1.76 | 11.1 | 2.38 | 7.3 |

A polyether polyurethane foam of the formulation identified above had a pore size of 45 ppi. The calculated surface area of the foam was 848 ft²/ft³. The butane flow rate was 250 mmin. The data from Table 1 are set out in graphical form in FIG. 7.

During fabrication and shipping, honeycomb extrusion activated carbon filters are notably fragile and easily damaged. A honeycomb extrusion was tested under compression according to a test method set out in ASTM 3574 using a Zwick Z010 materials testing machine. The 2.0″×1.5″×0.25″ sample was subjected to a low-velocity compressive force (2 inch per minute cross head speed). As the compression force on the sample increased over time, the strain and the force increased. At a strain of about 0.8%, the force started to drop, indicating that some layers within the honeycomb had collapsed. On further compression, the force required dropped further. At 7% strain, the honeycomb layers completely collapsed, as the measured force was zero. In ASTM 3574, hysteresis is the percent area between the IFD-strain curve and the return curve. The hysteresis for the honeycomb was 100%. FIG. 10 shows the hysteresis curves for the honeycomb extrusion 60 and for a comparison polyurethane foam filter media 62.

In comparison to the honeycomb extrusion, a polyurethane foam filter media is resilient and readily fabricated and shipped. A foam sample having dimensions of 2″×2″×1″ was also tested using the AS™ 3574 test method at a 2 inch per minute cross head speed. At forces that compressed the foam sample to 80% compression, the foam structure did not crumble (See FIG. 10). The hysteresis for the polyurethane foam sample was 60%. A sample with a lower hysteresis is more resilient and less subject to crumbling upon fabrication and shipping.

TABLE 2
BWC for Coated and Uncoated Foams with Varying Pore Size

| | Uncoated | | Coated | BWC |
|---|---|---|---|---|
| | g butane | BWC (W/W %) | g butane | (W/W %) |
| Ether foams | | | | |
| Pore size | | | | |
| reticulated | | | | |
| (1.4 pcf) | | | | |
| 20 ppi | 1.74 | 9.8 | 1.9 | 5.9 |
| 30 ppi | 1.81 | 10.6 | 2.0 | 6.0 |
| 45 ppi | 1.81 | 10.6 | 2.3 | 6.9 |
| 60 ppi | 1.98 | 9.9 | 2.6 | 6.9 |
| 80 ppi | 1.82 | 9.1 | 2.6 | 6.5 |
| 88 ppi | 1.82 | 11.4 | — | — |
| Higher density | | | | |
| (4.3 pcf) | | | | |
| 60 ppi | 2.89 | 6.7 | — | — |
| Nonreticulated | | | | |
| (1.4 pcf) | | | | |
| 20 ppi | 1.79 | 10.8 | — | — |
| 30 ppi | 1.84 | 10.5 | — | — |
| Lower density | | | | |
| (0.7 pcf) | | | | |
| 60 ppi | 1.54 | 16.6 | — | — |
| Graft Ether | | | | |
| Reticulated | | | | |
| (1.9 pcf) | | | | |
| 25 ppi | 2.02 | 9.0 | — | — |
| Ester foams | | | | |
| Reticulated | | | | |
| (2 pcf) | | | | |
| 20 ppi | 1.30 | 6.1 | — | — |
| 60 ppi | 1.31 | 6.3 | — | — |
| 75 ppi | 1.48 | 5.8 | — | — |
| (chem . . . ret.) | | | | |
| 75 ppi | 1.47 | 6.6 | — | — |
| Nonreticulated | | | | |
| (2 pcf) | | | | |
| 75 ppi | 1.48 | 5.9 | — | — |
| Melamine foam | | | | |
| Basotec (0.6 pcf) | 1.23 | 20.8 | — | — |
| Honeycomb | | | | |
| Activated carbon | | | | |
| (Comparison) | | | | |
| Small cylinder | 2.15 | 7.5 | — | — |
| 28.5 g | | | | |
| Large Cylinder | 6.04 | 7.9 | — | — |
| 76 g | | | | |

The calculated surface areas for the different pore sizes are as follows:

| | |
|---|---|
| 20 ppi | 325 ft²/ft³ |
| 30 ppi | 525 ft²/ft³ |
| 45 ppi | 848 ft²/ft³ |
| 60 ppi | 1190 ft²/ft³ |
| 75 ppi | 1549 ft²/ft³ |
| 80 ppi | 1672 ft²/ft³ |
| 90 ppi | 1921 ft²/ft³ |

Polymer networks with a greater surface area that may be contacted by the hydrocarbons entrained in a gaseous fluid stream generally have higher hydrocarbon absorption. However, networks with smaller pore sizes (e.g. 80 ppi and 90 ppi) can also have lower air permeabilities, which can limit contact between the hydrocarbons and the polymer material internal to the polymer network, and thus reduce hydrocarbon absorption.

FIG. 7 is a graph of the dynamic BWC (W/W %) over time for the coated and uncoated polyether polyurethane foam samples having a pore size of 45 ppi.

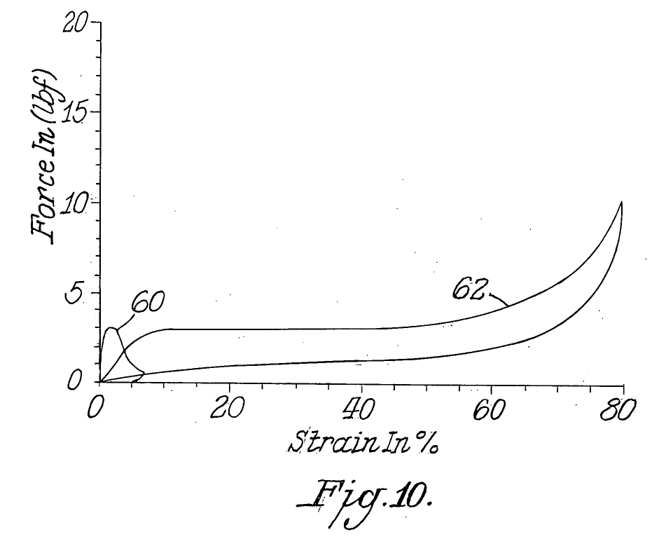

FIG. 8 is a graph comparing the BWC (W/W %) for coated and uncoated polyether polyurethane foams at varying pore sizes from 20 ppi to 80 ppi. In all cases, the uncoated polyurethane foams have a higher BWC (W/W %).

FIG. 9 is a graph comparing butane absorption (in grams or g butane) for coated and uncoated polyether polyurethane foams at varying pore sizes from 20 to 80 ppi. The adsorbent coating increases the adsorption of butane, but also increases sample weight and results in other problems associated with coatings, such as flake off. The uncoated foams have greater resilience, and do not have particulates that may flake off during use.

Those seeking to develop a filter medium for evaporative hydrocarbon emissions may tailor the performance by adding a coating or an adsorbent coating. We have found that uncoated filter media have excellent butane working capacity and satisfactory hydrocarbon absorption to use in secondary evaporative emission filters, among other uses.

The invention has been illustrated by detailed description and examples of the preferred embodiment. Various changes in form and detail will be within the skill of persons skilled in the art. Therefore, the invention must be measured by the claims and not by the description of the examples or the preferred embodiments.

1. A method for removing hydrocarbons from a gaseous stream emitted from a fuel tank during refueling a motor vehicle, device or appliance with a hydrocarbon-based fuel consuming engine, comprising:
installing a filter in a flow path established between the fuel tank and an exhaust from the fuel tank, wherein said filter comprises a polymer network and has a butane working capacity (W/W %) of at least 4.0 percent.

2. The method of claim 1, wherein the polymer network comprises a foam with a pore size between about 3 and about 300 ppi.

3. The method of claim 1, wherein the polymer network comprises a foam with a pore size between about 20 and about 90 ppi.

4. The method of claim 1, wherein the polymer network has an air permeability of 0.1 to 20 inches water pressure drop.

5. The method of claim 1, wherein the polymer network has an air permeability of 0.1 to 5 inches water pressure drop.

6. The method of claim 1, wherein the polymer network is formed from a material selected from the group consisting of urethanes, melamines, polyvinylchloride, acrylics, polyolefins, polyimides, ethylene vinyl acetate, polyvinyl acetate, polyvinyl alcohol and combinations of polymers and polymer derivatives.

7. The method of claim 2, wherein the foam is selected from the group consisting of polyether polyurethane foam, polyester polyurethane foam and melamine foam.

8. The method of claim 7, wherein the foam is reticulated.

9. The method of claim 1, wherein the polymer network comprises a nonwoven polymer, a collection of polymer particles, a collection of shredded particles of foam, a monolith of foam, multiple layers of foam, a coiled sheet of foam, or any combination thereof.

10. The method of claim 1, wherein a coating is applied to at least a portion of the polymer network.

11. The method of claim 10, wherein the coating comprises one or more materials selected from the group consisting of activated carbons, silicas, silicates, aluminosilicates, filter agents, molecular sieves, flame retardants, electrically conductive materials, antimicrobial additives, germicides, pigments and colorants.

12. A method for removing hydrocarbons from a gaseous stream emitted from a fuel tank during refueling a motor vehicle, device or appliance with a hydrocarbon-based fuel consuming engine, consisting essentially of:
installing a filter in a flow path established between the fuel tank and an exhaust from the fuel tank, wherein said filter comprises a cellular polymer foam having a pore size from 20 to 90 ppi and a butane working capacity (W/W %) of at least 8.0 percent.

13. A system for extracting evaporative hydrocarbon emissions from a motorized vehicle, device or appliance, comprising:
a housing defining an inner chamber;
an inlet through which a gas stream containing a hydrocarbon enters the inner chamber;
an outlet from which a gas stream exits the inner chamber; and
a filter comprising a polymer network and having a butane working capacity (W/W %) of at least 4.0 percent.

14. The system of claim 13, wherein the polymer network comprises a foam with a pore size between about 3 and about 300 ppi.

15. The system of claim 13, wherein the polymer network comprises a foam with a pore size between about 20 and about 90 ppi.

16. The system of claim 13, wherein the polymer network has an air permeability of 0.1 to 20 inches water pressure drop.

17. The system of claim 13, wherein the polymer network has an air permeability of 0.1 to 5 inches water pressure drop.

18. The system of claim 13, wherein the polymer network is formed from a material selected from the group consisting of urethanes, melamines, polyvinylchoride, acrylics, polyimides, polyolefins, polyvinyl acetate, polyvinyl alcohol, ethylene vinyl acetate, and combinations of polymers and polymer derivatives.

19. The system of claim 14, wherein the foam is selected from the group consisting of polyether polyurethane foam, polyester polyurethane foam and melamine foam.

20. The system of claim 19, wherein the foam is reticulated.

21. The system of claim 13, wherein the polymer network comprises a nonwoven polymer, a collection of polymer particles, a collection of shredded particles of foam, a monolith of foam, multiple layers of foam, a coiled sheet of foam, or any combination thereof.

22. The system of claim 13, wherein a coating is applied to at least a portion of the polymer network.

23. The system of claim 22, wherein the coating comprises one or more materials selected from the group consisting of activated carbons, silicas, silicates, aluminosilicates, filter agents, molecular sieves, flame retardants, electrically conductive materials, antimicrobial additives, germicides, pigments and colorants.

24. The system of claim 13, wherein the housing is a filter canister.

25. The system of claim 24, wherein two or more filters are included within the canister.

26. The system of claim 13, wherein the filter is formed as one or more disks insertable into the housing inner chamber in stacked relation.

27. The system of claim 13, wherein the housing inner chamber is generally cylindrical and the filter is formed as a rolled sheet inserted into said chamber.

28. The system of claim 13, wherein the filter is formed as a monolithic part formed with outer dimensions so as to fit within the housing inner chamber.
